(19) United States
(12) Patent Application Publication
(10) Pub. No.: US 2016/0253119 A1
(43) Pub. Date: Sep. 1, 2016

(54) STORAGE SYSTEM, STORAGE METHOD, AND RECORDING MEDIUM

(71) Applicant: NEC Corporation, Tokyo (JP)

(72) Inventor: JAMES SHUNSUKE REYNOLDS, Tokyo (JP)

(21) Appl. No.: 14/994,303

(22) Filed: Jan. 13, 2016

(30) Foreign Application Priority Data
Feb. 26, 2015 (JP) 2015-036215

(51) Int. Cl. G06F 3/06

(52) U.S. Cl. CPC G06F 3/0629; G06F 3/0604; G06F 3/0664; G06F 3/0683; G06F 3/0638

(57) ABSTRACT

A storage system according to the present invention includes: a network; and a plurality of storage devices, the storage device includes: a data storage unit which includes one or more containers storing data as a configuration of a virtual node logically configured across the plurality of storage devices, and the storage device further includes: a fragment processing unit which generates fragment data by dividing data received via the network into a predetermined number of pieces, and transmits the fragment data to another storage device via the network; a state determination unit which monitors a configuration state of other storage devices in the network, and determines configuration change, and a virtual node management unit which creates virtual nodes in a plurality of sizes when the state determination unit detects configuration change of the storage devices, in accordance with configuration of storage devices after change.

This application is based upon and claims the benefit of priority from Japanese Patent Application No. 2015-036215, filed on Feb. 27, 2015, the disclosure of which is incorporated herein in its entirety by reference.

### TECHNICAL FIELD

The present invention relates to data storage, and in particular, to a storage system, a storage method, and a recording medium, which store data in a distributed manner.

### BACKGROUND ART

In order to flexibly accommodate increase or decrease in a data amount, configuration change of a storage device, and the like, an information processing device such as a server adopts a storage system configured by using a plurality of storage devices (storage nodes) placed in a distributed manner (refer to, for example, Japanese Unexamined Patent Application Publication No. 2010-079886).

Referring to a drawing, a common storage system with distributed placement of storage nodes as described in Japanese Unexamined Patent Application Publication No. 2010-079886 will be described.

FIG. 2 is a block diagram illustrating an example of a configuration of a common storage system 120. The storage system 120 receives data from a server 110 and transmits data to the server 110. The storage system 120 includes an access node 130, a network 150, and a storage node 140.

The access node 130 receives data from the server 110 and writes the data to the storage node 140 via the network 150. Further, the access node 130 reads data from the storage node 140 via the network 150 and transmits the data to the server 110.

The storage node 140 receives data from the access node 130 via the network 150 and stores the data in an unillustrated disk device included in the storage node 40.

The network 150 relays data between the nodes described above.

Next, referring to drawings, data distributed to storage nodes 140 will be described.

The storage nodes 140 operate in coordination with each other via the network 150, place data in a distributed manner, and retain data. Consequently, one of the storage nodes 140 plays a leader role and executes virtual node setting and data fragmentation as described below. Any storage node 140 may play a leader role. The storage node 140 is described as a storage node 140 in a leader role in the description below unless otherwise specified. Further, it is assumed that a virtual node is already set to the storage node 140.

FIG. 3 is a diagram illustrating an example of a data storage method in the storage node 140. FIG. 3 illustrates a case in which one piece of block data 602 is placed in a distributed manner as nine pieces of fragment data 603 and three pieces of redundant parity 604.

In FIG. 3, a virtual node 410 that stores data is configured across a plurality of the storage nodes 140. The virtual node 410 includes a data storage container 411 that stores data. A leading bit string 412 is information used for selecting (identifying) the virtual node 410. The leading bit string 412 will be described later.

The access node 130 in the storage system 120 receives stored data 601 to be stored in the storage node 140 from the server 110, and divides the stored data 601 into predetermined-sized pieces of block data 602 as illustrated in FIG. 3. Further, the access node 130 calculates a hash value corresponding to the data. Then, the access node 130 transmits the block data 602 and the hash value to the storage node 140 in a leader role.

The storage node 140 divides the block data 602 into a predetermined number of equal-sized pieces (hereinafter D pieces) of fragment data 603. Further, the storage node 140 calculates a predetermined number of pieces (hereinafter P pieces) of redundant fragment data as redundant parity 604 corresponding to the block data 602, and adds the redundant fragment data to the fragment data 603. The sum of D and P is hereinafter denoted as F (F=D+P). FIG. 3 illustrates a case where “D=9”, “P=3”, and “F=12.” The storage system 120 may change values of D and P without limiting to the values indicated in FIG. 3.

Then, the storage node 140 delivers F equal-sized pieces of fragment data 605 combining the fragment data 603 and the redundant parity 604 to a plurality of the storage nodes 140 in a distributed manner. In other words, the storage node 140 stores the fragment data 605 in F data storage containers 411 belonging to the virtual node 410 configured across a plurality of the storage nodes 140, in a distributed manner.

FIG. 4 is a diagram for describing the virtual node 410 that stores data.

As illustrated in FIG. 4, a plurality of the virtual nodes 410 are configured across the storage nodes 140 in the storage system 120. FIG. 4 illustrates four virtual nodes 410 as an example.

The storage node 140 determines which virtual node 410 stores which fragment data 605, based on a value of a predetermined number of bits from the start of a hash value of the block data 602 (leading bit string 412).

FIG. 4 illustrates a case in which there are four virtual nodes 410. Note that “4” can be classified by two bits. Consequently, the storage node 140 determines the virtual node 410 used as a storage area, based on the first two bits of a hash value of the block data 602 (leading bit string 412). For example, when a hash value is “00001111 . . . , ” the leading bit string 412 is “00.” Thus, the fragment data 605 are stored in the virtual node 410 corresponding to the leading bit string 412 “00.”

The fragment data 605 generated from the block data 602 of a same size has the same size. Consequently, a same data amount is written to the data storage container 411 belonging to a same virtual node 410. In other words, a data amount included in the data storage container 411 belonging to a same virtual node 410 is uniform. Furthermore, each virtual node 410 corresponds to the leading bit string 412 of a hash value with the same number of bits. Therefore, when a data amount written to the storage system 120 is sufficiently large, the total data amount written to the respective virtual nodes 410 is mostly uniform. Thus, the data storage containers 411 included in the storage system 120 respectively store a mostly uniform data amount.

When the number of storage nodes 140 included in the storage system 120 is changed, the storage node 140 attempts to move the data storage container 411 between storage nodes 140 in order to maintain a uniform distribution state.

However, when the total number of data storage containers 411 is not divisible by the number of storage nodes 140, distributed placement of the data storage containers 411 is not uniform. Optimal distributed placement within the limits of the possibility makes the number of data storage containers 411 included in part of the storage nodes 140 less than the number of data storage containers 411 included in the other storage nodes 140 by one. Thus, an unavailable area is created in the storage node 140 including a less number of data storage containers 411. Consequently, capacity efficiency of the storage system 120 is degraded.

As a method for reducing an unavailable area, a method that increases the number of virtual nodes 410 or the number of data storage containers 411 per virtual node 410 can be envisioned. Increasing the number of virtual nodes 410 represents increasing the total number of data storage containers 411. In other words, this method is a method that increases the data storage containers 411.

However, the data storage containers 411 mutually perform existence confirmation via communication. Consequently, traffic increases as the number of data storage containers 411 increases. Thus, there is a limit on the number of data storage containers 411 that can practically be created. In other words, the method that increases the number of data storage containers 411 has a problem that there is a limit on the number to be increased.

Alternatively, a method that changes a value of F described above and the number of virtual nodes 410 so that the total number of data storage containers 411 is divisible by the number of storage nodes 140, with every change in the number of storage nodes 140, can be envisioned.

However, a change in the number of data storage containers 411 requires an operation related to fragmentation as described below of the storage node 140. The storage node 140 reads and combines fragment data 605 included in the data storage containers 411. Then the storage node 140 re-divides the combined data into fragment data 605 and writes the data to a new data storage container 411. Thus, a change in the number of data storage containers 411 requires rewriting of all data. Therefore, a change in the number of data storage containers 411 significantly increases input and output (IO) processing cost. In other words, the method that changes a value of F described above also has limited applicability.

Thus, a change in the number of data storage containers 411 degrades scalability of the storage system 120. Consequently, a value of F is basically fixed in the storage system 120.

Further, the number of virtual nodes 410 is determined based on the number of storage nodes 140. Then, the number of data storage containers 411 is changed with the change in the number of virtual nodes 410. In other words, a method that changes the number of virtual nodes 410 also has limited applicability.

Thus, a technology described in Japanese Unexamined Patent Application Publication No. 2010-079886 has a problem that capacity efficiency cannot be enhanced.

### SUMMARY

An object of the present invention is to provide a storage system, a storage method, and a recording medium, capable of enhancing capacity efficiency without degrading redundancy and scalability.

A storage system according to an exemplary aspect of the present invention includes a network and a plurality of storage devices. The storage device includes: a data storage unit which includes one or more containers storing data as a configuration of a virtual node logically configured across the plurality of storage devices, and the storage device further includes: a fragment processing unit which generates fragment data by dividing data received via the network into a predetermined number of pieces, and transmits the fragment data to another storage device via the network; a state determination unit which monitors a configuration state of other storage devices in the network, and determines configuration change, and a virtual node management unit which creates virtual nodes in a plurality of sizes when the state determination unit detects configuration change of the storage devices, in accordance with configuration of storage devices after change.

A storage method according to an exemplary aspect of the present invention is for a storage system. The storage system includes: a network; and a plurality of storage devices including a data storage unit including one or more containers for storing data, the containers configuring a virtual node logically configured across the plurality of storage devices. The method includes: generating fragment data by dividing data received via the network into a predetermined number of pieces, and transmitting the fragment data to another storage device via the network; monitoring a configuration state of another storage device in the network; determining configuration change; and creating virtual nodes in a plurality of sizes when detecting configuration change of the storage device, in accordance with a configuration of a storage device after change.

A computer readable non-transitory recording medium according to an exemplary aspect of the present invention embodies a program. The program causes a storage system to perform a method. The storage system includes: a network; and a plurality of storage devices including a data storage unit including one or more containers for storing data, the containers configuring a virtual node logically configured across the plurality of storage devices. The method includes: generating fragment data by dividing data received via the network into a predetermined number of pieces, and transmitting the fragment data to another storage device via the network; monitoring a configuration state of another storage device in the network; determining configuration change; and creating virtual nodes in a plurality of sizes when detecting configuration change of the storage device, in accordance with a configuration of a storage device after change.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a configuration of a storage system according to a first exemplary embodiment of the present invention;

FIG. 2 is a block diagram illustrating an example of a configuration of a common distributed-placement storage system;

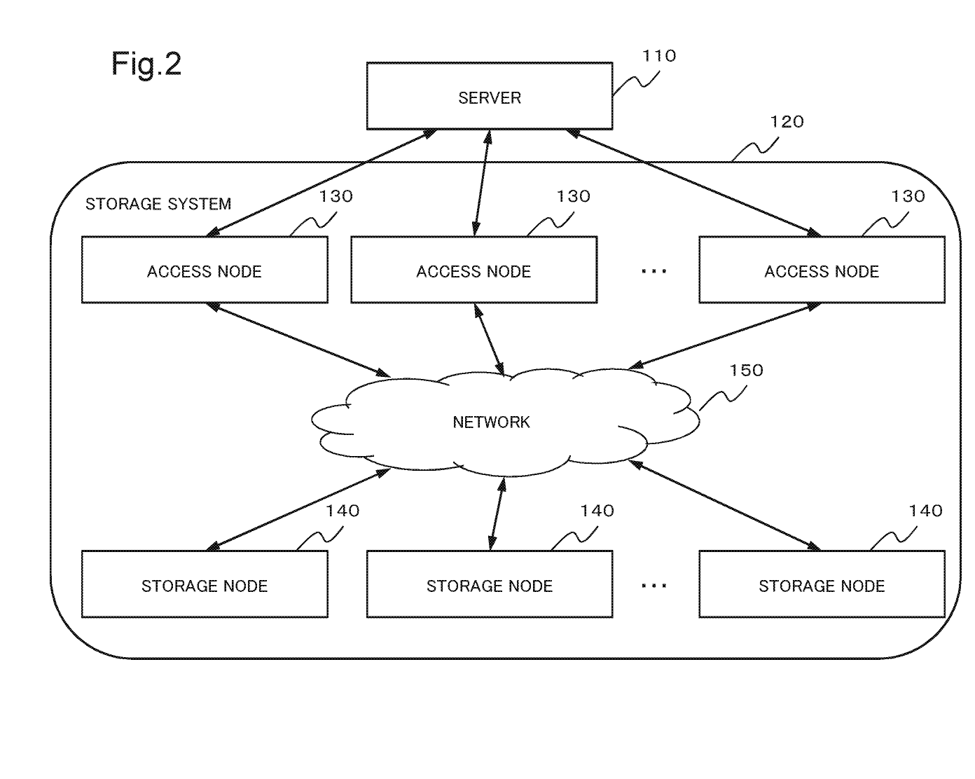

FIG. 3 is a diagram illustrating an example of a data storage method in a storage node;

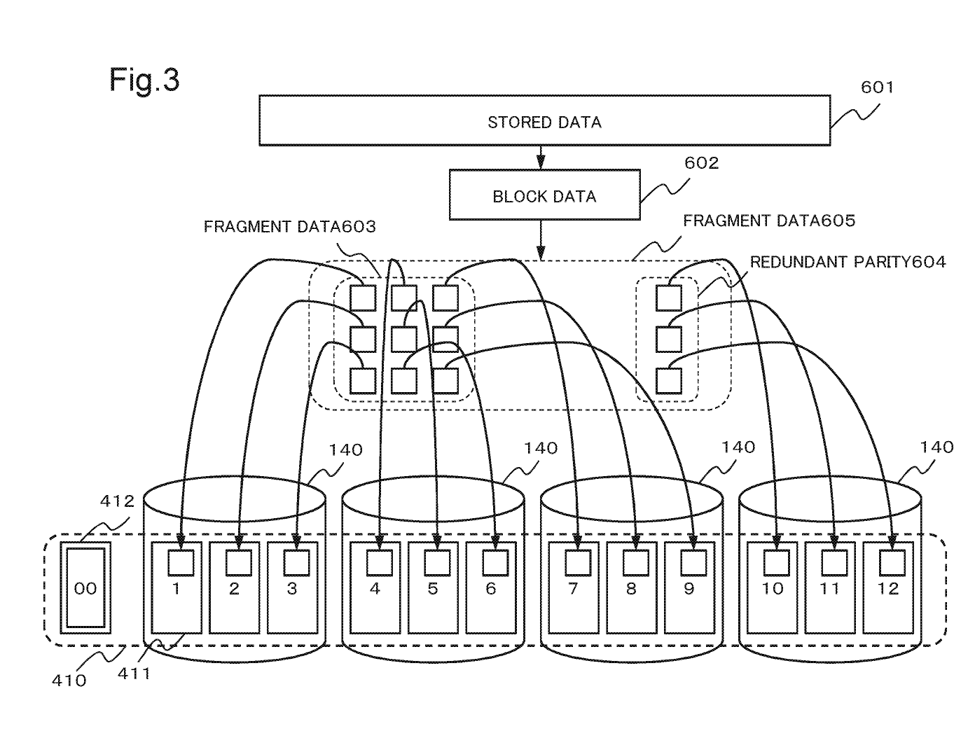

FIG. 4 is a diagram for describing a virtual node that stores data;

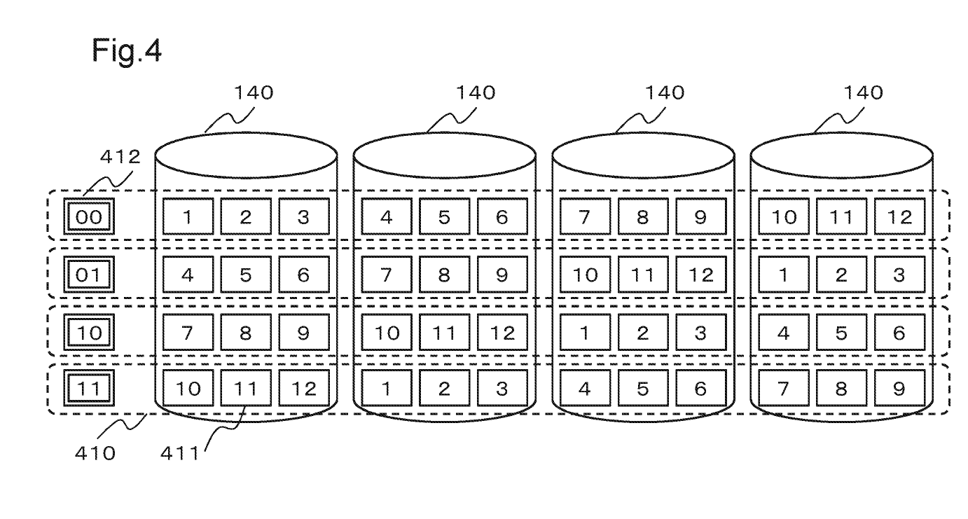

FIG. 5 is a diagram illustrating an example of a correspondence relation between the number of storage devices and the number of virtual nodes;

FIG. 6 is a diagram illustrating first example of divided hash ranges;

FIG. 7 is a diagram illustrating second example of divided hash ranges;

FIG. 8 is a diagram illustrating third example of divided hash ranges;

FIG. 9 is a flowchart illustrating an example of a data writing operation in a storage device according to the first exemplary embodiment;

FIG. 10 is a flowchart illustrating an example of a data reading operation in the storage device according to the first exemplary embodiment;

FIG. 11 is a flowchart illustrating an example of a virtual node setting operation upon configuration change of the storage device according to the first exemplary embodiment; and

FIG. 12 is a block diagram illustrating an example of a configuration of a modified example of the storage device according to the first exemplary embodiment.

### EXEMPLARY EMBODIMENT

An exemplary embodiment of the present invention will be described referring to the drawings.

Each drawing is for description of the exemplary embodiment of the present invention. However, the present invention is not limited to the description of the respective drawings. A same reference sign is assigned to a similar configuration in each of the drawings and repeated description thereof may be omitted.

Further, in the drawings used for the description below, description and illustration of a configuration of a part not related to description of the exemplary embodiment of the present invention may be omitted.

First, terms used in the description of the exemplary embodiment of the present invention will be summarized.

A “virtual node” is a logical group including a container for storing data. In other words, the virtual node is a virtual storage node (storage device). The virtual node is configured across a plurality of physically divided storage devices (storage nodes). Further, the virtual node is identified (distinguished) by using information corresponding to stored data. This identification information is not particularly limited. In the description of the exemplary embodiment of the present invention, a hash value obtained by applying a predetermined hash function to data is assumed to be used as an example of the identification information. More particularly, a leading bit string, to be described later, is assumed to be used as the identification information.

A “container” is a logical storage unit provided in the storage device as a configuration of the virtual node for storing fragment data. The container is created as a file, for example.

A “leading bit string” is a predetermined length of bit string from the start of a hash value, used for identifying the aforementioned virtual node. It is not necessary for the exemplary embodiment of the present invention to limit information for identifying the virtual node to a bit string from the start of a hash value. For example, the exemplary embodiment of the present invention may use a bit string extracted from a predetermined location of a hash value (for example, odd-numbered bits from the start). In the following description, the leading bit string also refers to a bit string not starting from the start. Further, the leading bit string is information for identifying the virtual node as described above. The virtual node stores data in the container. Thus, the leading bit string is information identifying the container storing data (index information) or information constituting part of the index information.

A “hash range” is a range of hash values corresponding to a same leading bit string. The container in the virtual node stores data including a hash value in a hash range to which the container corresponds.

“Fragment data” are data that are divided (fragmented) into a predetermined number of pieces of data. The exemplary embodiment of the present invention generates data for ensuring reliability of received data (hereinafter referred to as “redundant parity”), and divides (fragments) and stores the data, similarly to the received data. Thus, fragment data hereinafter include redundant parity. However, the exemplary embodiment of the present invention may store fragment data not including redundant parity.

A “virtual node granularity” is a value indicating a degree of fineness in virtual node setting. For example, the virtual node is more minutely set when the granularity value or a range of the granularity value (G) is large. The granularity value may be defined reversely. In other words, the virtual node may be set more minutely when the granularity value is small.

The storage devices according to the exemplary embodiment of the present invention are connected via the network, and are network nodes. Thus, the storage device is also referred to as a storage node.

### First Exemplary Embodiment

A first exemplary embodiment of the present invention will be described referring to the drawings.

[Description of Configuration]

First, a configuration of a storage system 20 according to the first exemplary embodiment will be described referring to the drawing.

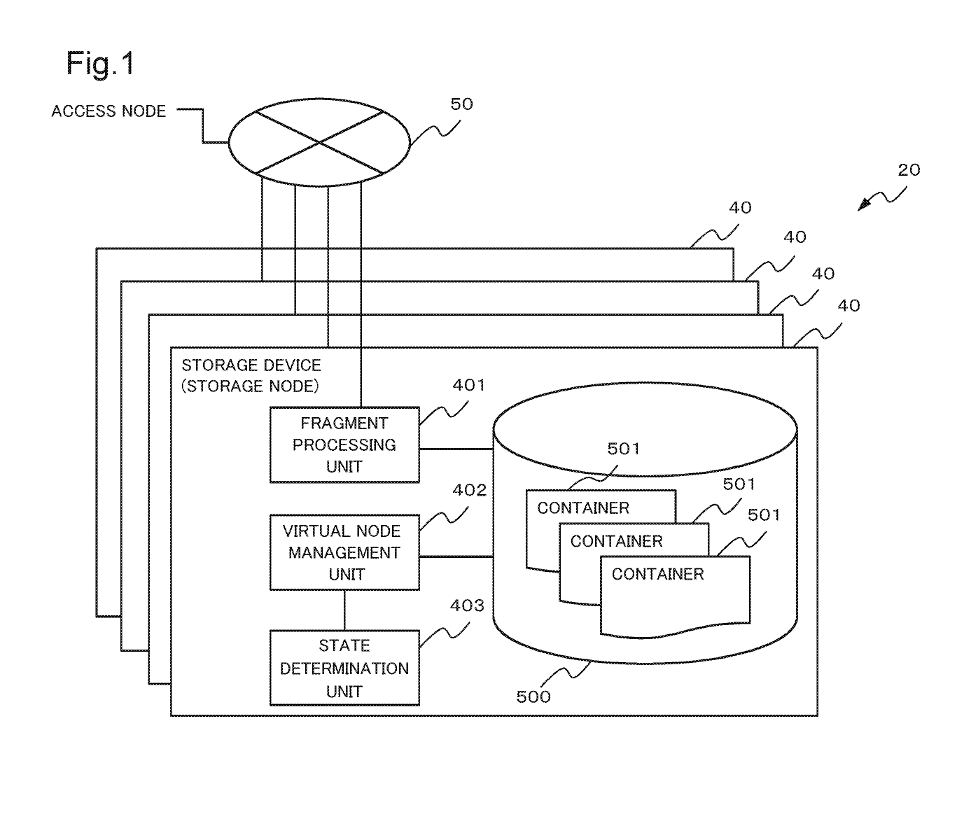

FIG. 1 is a block diagram illustrating an example of a configuration of the storage system 20 according to the first exemplary embodiment.

The storage system 20 includes a plurality of storage devices (storage nodes) 40 and a network 50.

The network 50 is a communication network that connects an unillustrated access node and the storage device 40. The network 50 also relays data communication between the storage devices 40. The network 50 according to the present exemplary embodiment is not limited to a specific communication method and a specific communication format. For example, the network 50 may be a common communication network such as a local area network (LAN) or Fiber Channel. Thus, detail description of the network 50 is omitted.

The storage device 40 stores data received from the access node via the network 50 into a plurality of storage devices 40 in a distributed manner. When receiving data, the storage device 40 receives a hash value corresponding to the data.

The storage device 40 includes a fragment processing unit 401, a virtual node management unit 402, a state determination unit 403, and a data storage unit 500.

The storage device 40 that operates as a leader executes major operations described below. The following description refers to the storage device 40 that operates as a leader, unless otherwise specified.

The fragment processing unit 401 divides (fragments) data received from the access node and generates fragment data. The fragment processing unit 401 also generates redundant parity. The fragment processing unit 401 extracts a predetermined length of bit string from the start of a hash value as a leading bit string. Then, the fragment processing unit 401 distributes the fragment data and the leading bit string to other storage devices 40 via the network 50. The storage device 40 may transmit a different piece of information that specifies a virtual node instead of the leading bit string.

The fragment processing unit 401 in each storage device 40 determines the container 501 in the virtual node that stores fragment data, based on the leading bit string transmitted from the storage device 40 in a leader role, and stores the fragment data in the container 501. The storage device 40 in a leader role stores fragment data to be stored in the local device into the container 501 in the local device. In other words, the storage device 40 does not distribute fragment data to be stored into the container 501 in the local device.

Further, the fragment processing unit 401 in the storage device 40 in a leader role collects fragment data stored in the container 501 in each storage device 40, and combines the collected fragment data to generate data to be returned to the access node. Then, the fragment processing unit 401 transmits the generated data to the access node via the network 50.

The data storage unit 500 includes the container 501 for storing fragment data. The data storage unit 500 is, for example, a magnetic disk device, an optical disk device, or a solid state drive (SSD).

The container 501 stores fragment data. The container 501 includes the leading bit string or index information so that a location of fragment data can be referred to by using a hash value, as will be described later. The index information is information including information related to fragment data (such as a location of fragment data in the container 501) in addition to the leading bit string. The container 501 is, for example, a logical file. One or more containers 501 are created in the data storage unit 500, based on virtual node setting. The index information may be stored in an unillustrated storage unit instead of each container 501 by an unillustrated control unit in the data storage unit 500. In that case, the control unit stores fragment data in the container 501, based on the index information stored in the storage unit.

The virtual node management unit 402 manages the number of virtual nodes including the container 501, and the leading bit string and the hash range corresponding to the virtual node, based on the number of storage devices 40 (storage nodes). Specifically, the virtual node management unit 402 executes addition and deletion of the virtual node as virtual node management.

The state determination unit 403 monitors operation status (confirmation of existence) of the storage device 40 configuring the virtual node, via the network 50. Then, the state determination unit 403 determines whether or not configuration change of the storage device 40 in normal operation (existence) has occurred. More specifically, the state determination unit 403 determines whether or not increase or decrease in the number of storage devices 40 in normal operation has occurred. When determining that configuration change (increase or decrease in the number) of the storage devices 40 has occurred, the state determination unit 403 notifies the configuration change to the virtual node management unit 402.

Normal operation in this context refers to operation of the storage device 40 being able to provide a storage function in the storage system 20. In other words, normal operation refers to being able to receive fragment data from the storage device 40 in a leader role, and transmit fragment data to the storage device 40 in a leader role.

[Description of Operation]

Next, an operation according to the present exemplary embodiment will be described referring to the drawings.

More particularly, each operation of data writing, data reading, and virtual node setting accompanying configuration change, in the storage system 20, will be described.

(Data Writing)

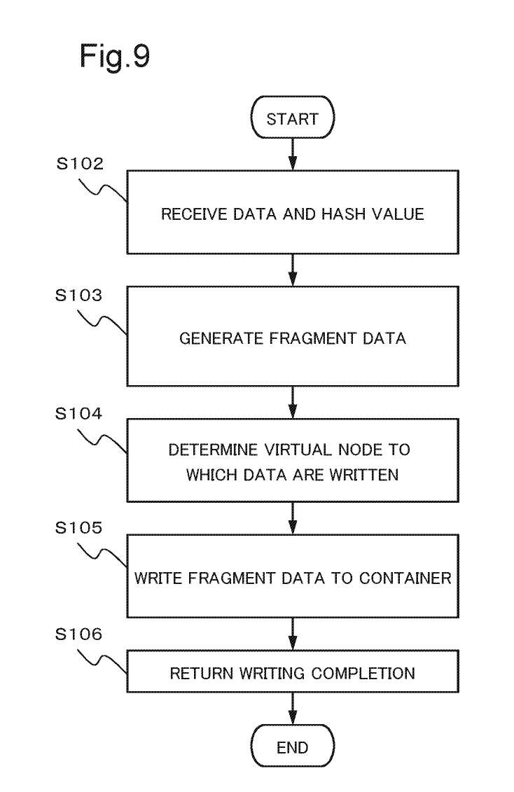

FIG. 9 is a flowchart illustrating an example of a data writing operation in the storage device 40 according to the first exemplary embodiment.

The fragment processing unit 401 receives data to be stored and a hash value corresponding to the data from the access node (Step S102).

The leading bit string is generated based on the hash value. The leading bit string is information for identifying the virtual node. In other words, the storage device 40 creates information for identifying the virtual node, based on information related to the data received via the network 50.

Then, the fragment processing unit 401 divides the data, generates redundant parity, and generates fragment data (Step S103).

The fragment processing unit 401 determines a virtual node to which the fragment data are written based on the leading bit string being a predetermined length of bit string from the start of the hash value (Step S104).

The fragment processing unit 401 in the storage device 40 in a leader role distributes the fragment data and the leading bit string to each storage device 40 placed in a distributed manner via the network 50.

The fragment processing unit 401 in each storage device 40 determines a container 501 included in the virtual node to which the received fragment data is written based on the leading bit string, and writes the fragment data to the determined container 501 (Step S105). The fragment processing unit 401 in each storage device 40 stores a correspondence relation (part of the index information) between the leading bit string and the fragment data written to the container 501.

After all the fragment data are stored in the container 501, the fragment processing unit 401 returns a result of writing completion to the access node (Step S106). When the storage system 20 uses write-back, the storage device 40 may return writing completion to the access node upon completion of Step S102.

(Data Reading)

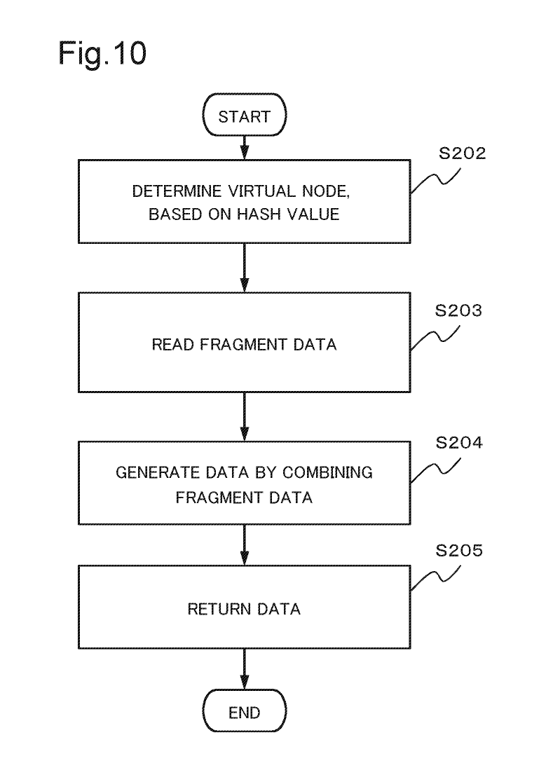

FIG. 10 is a flowchart illustrating an example of a data reading operation in the storage device 40 according to the first exemplary embodiment.

The fragment processing unit 401 determines a virtual node in which fragment data are stored, based on a hash value received from the access node (Step S202). More particularly, the fragment processing unit 401 generates a leading bit string from the hash value and determines the virtual node based on the leading bit string.

The fragment processing unit 401 reads the fragment data from the container 501 in the virtual node in each storage device 40 via the network 50, by using the leading bit string (Step S203).

The fragment processing unit 401 in each storage device 40 reads the fragment data stored in the container 501, based on the leading bit string and the index information stored upon writing.

The fragment processing unit 401 generates data to be returned to the access node by combining the read fragment data (Step S204).

The fragment processing unit 401 returns the generated data to the access node (Step S205).

(Setting of Virtual Node at the Time of Configuration Change)

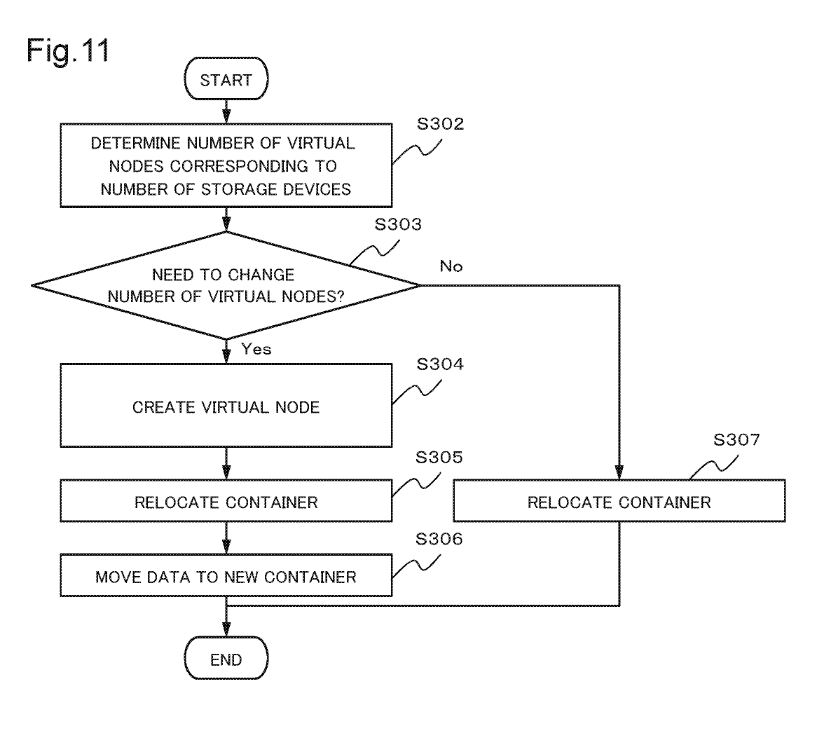

FIG. 11 is a flowchart illustrating an example of a virtual node setting operation in the time of configuration change in the storage device 40 according to the first exemplary embodiment.

First, premises in the description will be summarized.

It is assumed that a constant (G) representing a range of a virtual node granularity is preset to the storage device 40. It is also assumed that “G=1” in the following description.

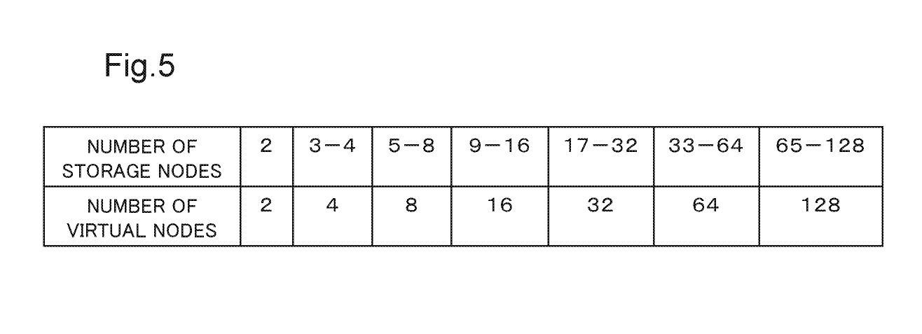

Further, it is assumed that correspondence between the number of storage devices 40 and the number of virtual nodes is preset to the storage device 40. FIG. 5 is a diagram illustrating an example of a correspondence relation between the number of storage devices 40 and the number of virtual nodes, used in the following description. However, correspondence between the number of storage devices 40 and the number of virtual nodes according to the present exemplary embodiment is not limited to FIG. 5.

Further, the operation described below is an operation after the state determination unit 403 detects configuration change of the storage device 40 and notifies the virtual node management unit 402 of the configuration change.

The operation will be specifically described below.

When receiving a configuration change notice from the state determination unit 403, the virtual node management unit 402 determines the number of virtual nodes corresponding to the number of storage devices 40 after the configuration change, based on the correspondence relation between the number of storage devices 40 and the number of virtual nodes (refer to FIG. 5) (Step S302). The virtual node management unit 402 may determine the number of virtual nodes by using of a predetermined formula instead of a table as illustrated in FIG. 5.

Then, the virtual node management unit 402 determines whether or not the number of virtual nodes needs to be changed, based on comparison between the determined number of virtual nodes and the current number of virtual nodes (Step S303). The virtual node management unit 402 may determine whether or not the number of storage devices 40 after the configuration change is included in a range of the number of storage devices 40 corresponding to the currently set number of virtual nodes.

When the number of virtual nodes does not need to be changed (No in Step S303), the virtual node management unit 402 does not need to change data held by the container 501 in the virtual node. The virtual node management unit 402 relocates the container 501, in accordance with the storage device 40 after the configuration change (Step S307). For example, the virtual node management unit 402 moves the container 501 between the storage devices 40. There is a case in which relocation of the container 501 is not needed. In such a case, the virtual node management unit 402 performs no further operation and ends the operation.

When the number of virtual nodes needs to be changed (Yes in Step S303), the virtual node management unit 402 creates (or deletes) a virtual node. This operation will be described in detail later.

At the time of completion of virtual node creation (or deletion), the virtual node management unit 402 relocates the container 501 in the storage device 40 after the configuration change (Step S305).

After the relocation of the container 501, the fragment processing unit 401 moves data to a new container 501. In other words, the fragment processing unit 401 reads data stored in the container 501 before the configuration change, and stores (writes) the data into the new container 501 after the configuration change (Step S306).

Next, the operation of virtual node creation in Step S304 will be further described.

First, variables used in the following description will be described.

The number of virtual nodes corresponding to the storage device 40 after the configuration change is denoted as “n”. Furthermore, n is a power of two (refer to FIG. 5).

The length (number of bits) of the leading bit string is denoted as “L.” As will be described later, the lengths of the leading bit strings have different values. Consequently, a subscript is added to “L” when distinguishing the lengths of the leading bit strings (L). The length of a leading bit string to be set first is denoted as “L₁”, and the followed lengths of leading bit strings are denoted as “L₂”, “L₃”, . . . .

The number of hash ranges after division is denoted as “m.” Division of the hash range is varied as will be described later. Consequently, a subscript is added to “m” when distinguishing the numbers of hash ranges (m). The number of hash ranges after a first division is denoted as “m₁” and the followed numbers of hash ranges are denoted as “m₂”, “m₃”, . . . .

The virtual node management unit 402 determines the length of the first leading bit string (L₁) and the first division number of hash ranges (m₁) as follows. The virtual node management unit 402 uses the following equation to determine the length of the first leading bit string (L₁).

L₁=log₂ n)−G [unit is bit] [Equation 1]

Then, the virtual node management unit 402 sets the division number of the hash range (m₁), identified by using the leading bit string with the length described above (L₁), to “n/2^{G} [pieces].”

A case where n=8 will be described as an example.

In this case, the virtual node management unit 402 calculates “L₁=2(=(Log₂ 8)−1=3−1) [bits]” as the length of the first leading bit string (L₁). Further, the virtual node management unit 402 calculates 4(=8/2¹=8/2) as the number of hash ranges (m₁). In other words, the virtual node management unit 402 divides the hash range into four parts.

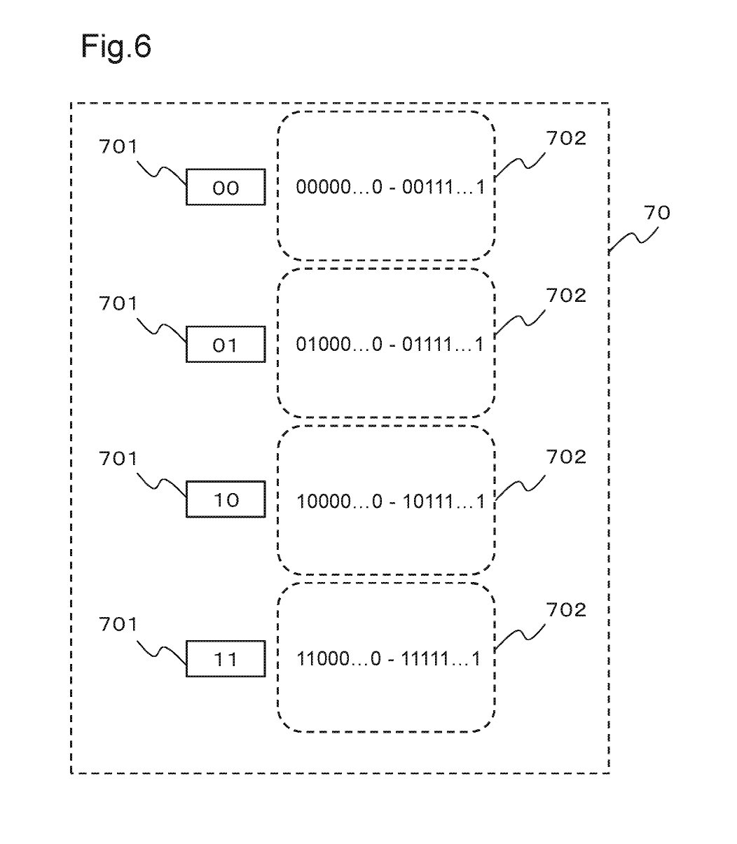

FIG. 6 is a diagram illustrating first example of a hash range after the division in this case (the first division).

In FIG. 6, a leading bit string 701 is a bit string with a 2-bit length (L₁=2). A hash range 70 that includes all hash values is divided into four hash ranges 702 (m₁=4).

Then, the virtual node management unit 402 executes the following operation until the division number of hash ranges (m) becomes the number of virtual nodes (n=8).

In this case, the division number of hash ranges (m₁=4) is less than the number of virtual nodes (n=8). Consequently, the virtual node management unit 402 continues division of the hash range.

The virtual node management unit 402 selects a hash range with a minimum number of elements (a range of hash range values) out of the divided hash ranges. Then, the virtual node management unit 402 selects half the number of the hash ranges in descending order of leading bit string value in the selected hash ranges.

The number of elements in all hash ranges is the same after the first hash range division. Consequently, the virtual node management unit 402 has only to select half the number of the hash ranges in descending order of leading bit string value. For example, in case of FIG. 6, the virtual node management unit 402 selects hash ranges 702 with the leading bit string 701 values corresponding to “10” and “11.”

Then, the virtual node management unit 402 increases the length of the leading bit string (L), indicating the hash range, by one bit (L₂=L₁+1=3) for the selected hash ranges. In other words, the virtual node management unit 402 doubles the number of leading bit strings corresponding to the selected hash ranges. Then, the virtual node management unit 402 divides the hash ranges to make the ranges correspond to the leading bit strings.

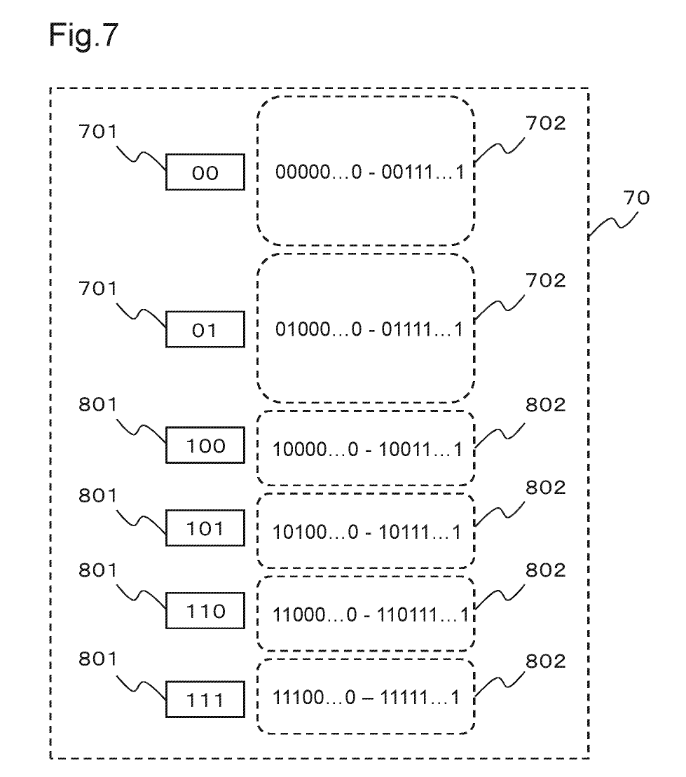

FIG. 7 is a diagram illustrating second example of the hash range after the division in this case (the second division).

The virtual node management unit 402 generates leading bit strings 801 “100” and “101” illustrated in FIG. 7 from the leading bit string 701 “10” illustrated in FIG. 6. Similarly, the virtual node management unit 402 generates leading bit strings 801 “110” and “111” illustrated in FIG. 7 from the leading bit string 701 “11” illustrated in FIG. 6. Then, the virtual node management unit 402 divides the two hash ranges 702 illustrated on the lower side of FIG. 6 into four hash ranges 802 corresponding to the leading bit strings 801.

Consequently, the number of hash ranges (m₂) becomes “6.” However, the number of hash ranges (m₂=6) is less than the number of virtual nodes (n=8). Consequently, the virtual node management unit 402 further divides the hash range.

Similar to the description above, out of hash ranges with a minimum number of elements (a range of hash range values), the virtual node management unit 402 selects half the number of the hash ranges in descending order of leading bit string value. In the case of FIG. 7, the virtual node management unit 402 selects hash ranges 802 corresponding to the leading bit strings 801 “110” and “111.”

Then, the virtual node management unit 402 increases the length of the leading bit string (L), indicating the hash range, by one bit (L₃=L₂+1=4) for the selected hash ranges. In other words, the virtual node management unit 402 doubles the number of leading bit strings corresponding to the selected hash ranges. Then, the virtual node management unit 402 divides the hash ranges to make the ranges correspond to the leading bit strings.

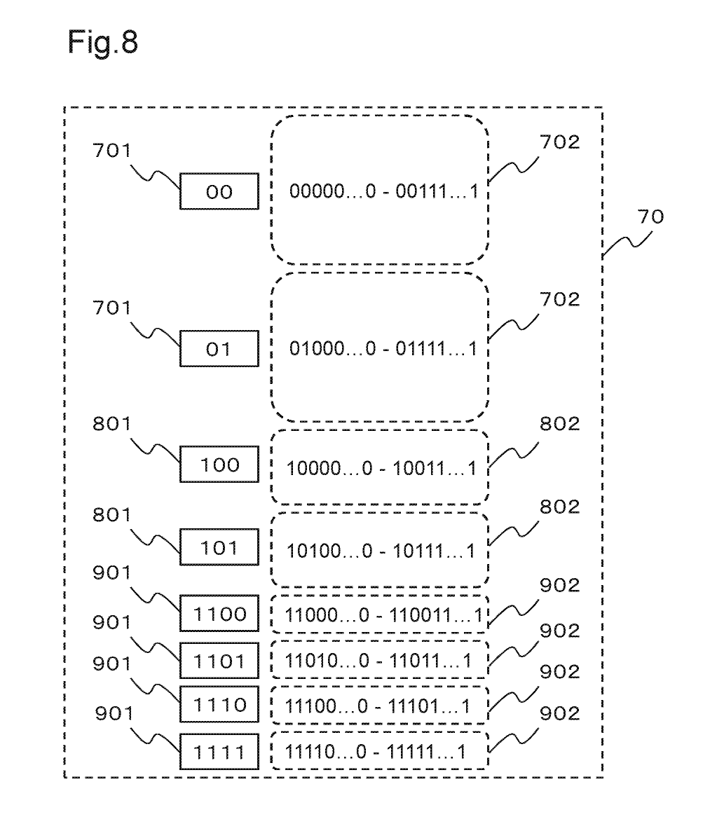

FIG. 8 is a diagram illustrating third example of the hash range after the division in this case (the third division).

The virtual node management unit 402 generates leading bit strings 901 “1100” and “1101” illustrated in FIG. 8 from the leading bit string 801 “110” illustrated in FIG. 7. Similarly, the virtual node management unit 402 generates leading bit strings 901 “1110” and “1111” illustrated in FIG. 8 from the leading bit string 801 “111” illustrated in FIG. 7. Then, the virtual node management unit 402 divides the two hash ranges 802 illustrated on the lower side of FIG. 7 into four hash ranges 902 corresponding to the leading bit strings 901.

Consequently, the number of hash ranges (m₃) becomes “8.” In other words, the number of hash ranges (m₃=8) is equal to the number of virtual nodes (n=8).

Consequently, the virtual node management unit 402 ends division of the hash range.

Thus, the virtual node management unit 402 divides the hash range to make ranges (extents) of hash ranges in a ratio of “4:2:1” as illustrated in FIG. 8, as division of the hash range. In other words, the virtual node management unit 402 divides the hash range in graduated sizes.

As described above, the virtual node management unit 402 makes the size of the hash range bear an inverse relation to the length of the leading bit string.

The reason is as follows.

A large-sized hash range is frequently selected. Hash range determination time is in proportion to the length of the leading bit string. Thus, when a short leading bit string is assigned to a large-sized hash range, hash range determination time for identifying the virtual node in the fragment processing unit 401 becomes short. In other words, the storage device 40 provides an effect of reducing fragment data write/read time.

Come back to the description of hash range division.

The virtual node management unit 402 associates each hash range and each leading bit string with a virtual node after division of the hash range. In other words, the virtual node management unit 402 is capable of creating virtual nodes in graduated sizes.

Then, the virtual node management unit 402 requests creation of a container 501 included in the virtual node to each storage device 40.

The virtual node management unit 402 may select half the number of the hash ranges in ascending order of leading bit string instead of descending order. Alternatively, the virtual node management unit 402 may select half the number of the hash ranges from a predetermined location such as the center.

Further, the virtual node management unit 402 may select another ratio (such as 1/3 and 1/4) of the hash ranges instead of half (1/2). Note that “1, 2, and 4” are part of a geometric progression with a common ratio of “2.” In other words, the virtual node management unit 402 in the description so far creates a virtual node in such a manner that a ratio of the sizes of virtual nodes is part of a geometric progression with a common ratio of “2.”

Thus, the aforementioned description that another ratio may be selected refers to the virtual node management unit 402 being able to use a value other than “2” as a common ratio of a geometric progression that determines graduated sizes of hash ranges. In other words, the virtual node management unit 402 may create virtual nodes with graduated sizes, the sizes being part of a geometric progression with a common ratio other than “2.”

### Description of Advantageous Effects

Next, advantageous effects according to the present exemplary embodiment will be described.

The storage device 40 in the storage system 20 according to the first exemplary embodiment is able to provide an effect of enhancing capacity efficiency without degrading redundancy and scalability.

The reason is as follows.

The state determination unit 403 in the storage device 40 included in the storage system 20 according to the present exemplary embodiment detects configuration change of the storage device 40. When configuration change occurs, the virtual node management unit 402 performs virtual node setting corresponding to the configuration after the change. The virtual node management unit 402 divides the hash range, to which virtual nodes are assigned, so as to perform division with different ranges instead of uniform division. For example, the virtual node management unit 402 divides the hash range to make a ratio of hash ranges “4:2:1.” Then, the virtual node management unit 402 assigns the hash ranges with different sizes to virtual nodes.

Thus, the storage device 40 according to the present exemplary embodiment is capable of creating virtual nodes in graduated sizes. Consequently, the storage device 40 according to the present exemplary embodiment is able to reduce areas unavailable for data storage. In other words, the storage device 40 according to the present exemplary embodiment is able to execute distributed placement with high capacity efficiency.

Further, the number of containers 501 per virtual node in the storage device 40 according to the present exemplary embodiment is similar to a common distributed-placement storage system.

Thus, the storage system 20 according to the present exemplary embodiment does not degrade redundancy and scalability.

For example, a correspondence relation between the number of storage devices 40 and the number of virtual nodes in the storage system 20 according to the present exemplary embodiment is similar to a correspondence relation in a common distributed-placement storage system. Consequently, occurrence frequency of change in the number of virtual nodes according to the present exemplary embodiment is similar to a common distributed-placement storage system.

Furthermore, the storage device 40 provides an effect of reducing fragment data write/read time.

The reason is as follows.

The virtual node management unit 402 makes the size of the hash range in inverse proportion to the length of the leading bit string. Thus, a frequently-selected and large-sized hash range has a short leading bit string used for determination. Consequently, hash range determination time in the fragment processing unit 401 becomes short. Thus, the storage device 40 according to the present exemplary embodiment provides an effect of reducing fragment data write/read time.

### MODIFIED EXAMPLE

The storage device 40 described above is configured as follows.

For example, each component of the storage device 40 may be configured with a hardware circuit.

Each component of the storage device 40 may also be configured by using a plurality of devices connected via a network.

The storage device 40 may include a plurality of components configured by one piece of hardware.

Further, the storage device 40 may be implemented as a computer device including a central processing unit (CPU), a read only memory (ROM), and a random access memory (RAM). The storage device 40 may also be implemented as a computer device including an input/output circuit (IOC) and a network interface circuit (NIC), in addition to the configuration described above.

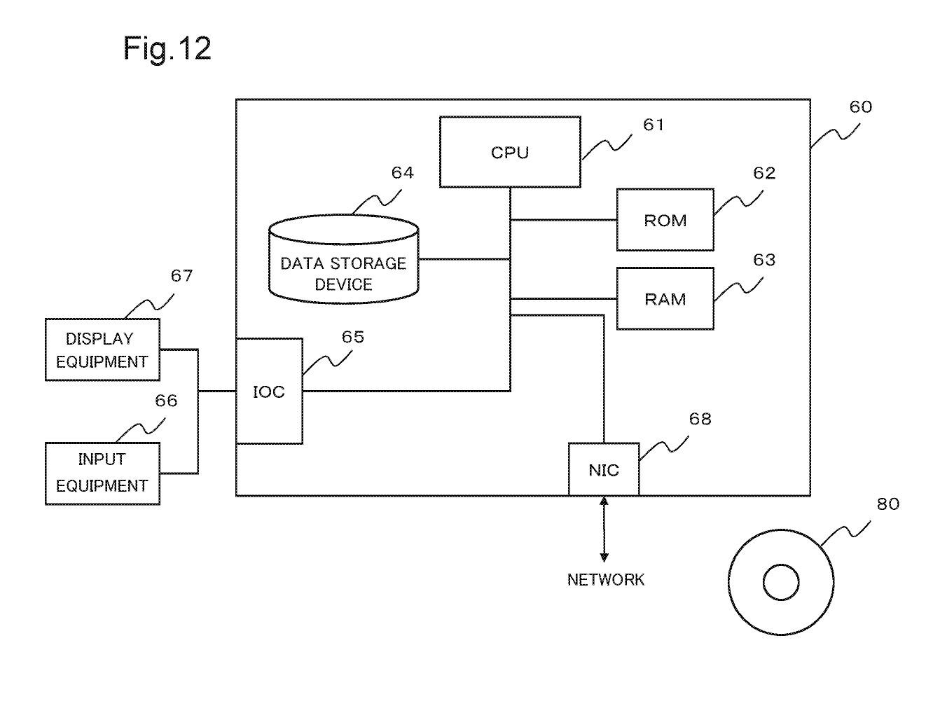

FIG. 12 is a block diagram illustrating an example of a configuration of a storage device 60 according to the present modified example.

The storage device 60 includes a CPU 61, a ROM 62, a RAM 63, a data storage device 64, an IOC 65, and a NIC 68, configuring a computer device.

The CPU 61 reads a program from the ROM 62. Then, the CPU 61 controls the RAM 63, the data storage device 64, the IOC 65, and the NIC 68, based on the read program. The computer including the CPU 61 controls these configurations and provides each function of the fragment processing unit 401, the virtual node management unit 402, and the state determination unit 403 illustrated in FIG. 1, respectively.

The CPU 61 may use the RAM 63 or the data storage device 64 as a temporary storage of a program when providing each function.

Further, the CPU 61 may read a program included in a storage medium 80 storing the program in a computer-readable manner, by using an unillustrated storage medium reading device. Alternatively, the CPU 61 may receive a program from an unillustrated external device via the NIC 68, store the program in the RAM 63, and operate based on the stored program.

The ROM 62 stores a program executed by the CPU 61, and static data. The ROM 62 is, for example, a programmable-ROM (P-ROM) or a flash-ROM.

The RAM 63 temporarily stores a program executed by the CPU 61, and data. The RAM 63 is, for example a dynamic-RAM (D-RAM).

The data storage device 64 stores data stored by the storage device 60 for a long time, and a program. Further, the data storage device 64 operates as the data storage unit 500 illustrated in FIG. 1. The data storage device 64 may also operate as a temporary storage device of the CPU 61. The data storage device 64 is, for example, a hard disk device, a magneto-optical disk device, a solid state drive (SSD), or a disk array device.

The ROM 62 and the data storage device 64 are non-transitory recording media. In other hand, the RAM 63 is a transitory recording medium. Further, the CPU 61 is capable of operating based on a program stored in the ROM 62, the data storage device 64, or the RAM 63. In other words, the CPU 61 is capable of operating by using a non-transitory recording medium or a transitory recording medium.

The IOC 65 mediates data between the CPU 61 and, input equipment 66 and display equipment 67. The IOC 65 is, for example, an IO interface card or a universal serial bus (USB) card.

The input equipment 66 is equipment that receives an input instruction from an operator of the storage device 60. The input equipment 66 is, for example, a keyboard, a mouse, or a touch panel.

The display equipment 67 is equipment that displays information to an operator of the storage device 60. The display equipment 67 is, for example, a liquid crystal display.

The NIC 68 relays communication between the storage device 60 and the network 50. The NIC 68 is, for example, a local area network (LAN) card.

The storage device 60 configured in this manner is able to provide an effect similar to the storage device 40.

The reason is that the CPU 61 in the storage device 60 is able to provide a function similar to the storage device 40, based on a program. The present invention is applicable to grid storage in which a redundant code is applied to a virtual storage device.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

1. A storage system comprising:
a network; and
a plurality of storage devices,
the storage device comprising:
a data storage unit which includes one or more containers storing data as a configuration of a virtual node logically configured across the plurality of storage devices, and
the storage device further comprising:
a fragment processing unit which generates fragment data by dividing data received via the network into a predetermined number of pieces, and transmits the fragment data to another storage device via the network;
a state determination unit which monitors a configuration state of other storage devices in the network, and determines configuration change, and
a virtual node management unit which creates virtual nodes in a plurality of sizes when the state determination unit detects configuration change of the storage devices, in accordance with configuration of storage devices after change.

2. The storage system according to claim 1, wherein
the virtual node management unit creates virtual nodes in graduated sizes, the sizes being part of a geometric progression.

3. The storage system according to claim 1, wherein
the virtual node management unit assigns a number of bits of information for identifying the virtual node so that the number bears an inverse relation to a size of a virtual node.

4. The storage system according to claim 1, wherein
the fragment processing unit reads fragment data from other storage devices via the network, and generates data by coupling fragment data.

5. The storage system according to claim 1, wherein
information for identifying the virtual node is created based on information related to data received via the network.

6. A storage method for a storage system, the storage system comprising:
a network; and
a plurality of storage devices including a data storage unit including one or more containers for storing data, the containers configuring a virtual node logically configured across the plurality of storage devices,
the method comprising:
generating fragment data by dividing data received via the network into a predetermined number of pieces, and transmitting the fragment data to another storage device via the network;
monitoring a configuration state of another storage device in the network;
determining configuration change; and
creating virtual nodes in a plurality of sizes when detecting configuration change of the storage device, in accordance with a configuration of a storage device after change.

7. A computer readable non-transitory recording medium embodying a program, the program causing a storage system to perform a method, the storage system comprising:
a network; and
a plurality of storage devices including a data storage unit including one or more containers for storing data, the containers configuring a virtual node logically configured across the plurality of storage devices,
the method comprising:
generating fragment data by dividing data received via the network into a predetermined number of pieces, and transmitting the fragment data to another storage device via the network;
monitoring a configuration state of another storage device in the network;
determining configuration change; and
creating virtual nodes in a plurality of sizes when detecting configuration change of the storage device, in accordance with a configuration of a storage device after change.
